(19) United States
(12) Patent Application Publication
(10) Pub. No.: US 2002/0173262 A1
(43) Pub. Date: Nov. 21, 2002

(54) Animal skinner and method

(76) Inventor: Kevin W. Stiefel, Groveland, FL (US)

Correspondence Address: Edward M. Livingston, Esq., 628 Ellen Dr., P.O. Box 1599, Winter Park, FL, 32790, US

(21) Appl. No.: 09/816,713

(22) Filed: Mar. 23, 2001

(51) Int. Cl. A22B 1/00

(52) U.S. Cl. 452/185

(57) ABSTRACT

An animal skinner has an animal fastener (2) on a hoist (1) vertically above a skin puller (3) on an upright (4, 17, 20, 23) that supports an animal body (5) and tension intermediate the animal fastener and the skin puller. Preferably the animal fastener includes a hang line (12) having a head loop (8) or a head hook (10) for fastening of a head (11), neck (9) or upper portion of an animal to be skinned while the animal body is being hoisted with the hoist. The hoist is preferably a winch (13), pulley or block and tackle (15). The hoist can have a winch crank (14) accessible conveniently to a person skinning the animal. The skin puller can include skin fasteners (7) on a skin spool (24) onto which skin of the animal body is wound controllably proximate a low portion of the upright while the animal body is being hoisted progressively with the hoist. Optionally, the skin puller can include one or more arrayed animal fasteners on an arrayer (29) anchored to the low portion of the upright for pulling the animal skin in opposition to upward movement of the animal body with the hoist. Preferably, the upright is anchored to a trailer-hitch (18) of a motor vehicle (19), but can be anchored otherwise or optionally substituted by a pole (23), a tree or other upright to which the hoist and the skin puller are attachable with adequate support and separation. A method for using this animal skinner describes attaching an animal to the animal attachment and pulling of its skin with the skin puller.

### BACKGROUND OF THE INVENTION

This invention relates to skinning or removing hide from large animals such as deer, elk, bear, buffalo, cows, hogs, sheep, horses, lions, wolves and seal by hunters, farmers and professional animal processors.

There are no known animal skinners that pull hide from an animal while it is being hoisted in a manner taught by this invention. Animal hoists are known, but are not animal skinners. Hunters, farmers and animal processors are left to maneuver animal bodies around on a ground or table surface while pulling hide from them. Some animal-processing plants have devised special animal skinners, but not with the convenience, portability and adaptivity to skinning a wide variety of animals as made possible by this invention.

Skinning animals with this invention can be done on site where an animal is slaughtered or later where it is hauled to be cut up or otherwise processed for use. Skinning animals on site immediately is highly preferable to waiting until they are hauled away. Immediate skinning prevents an almost immediate tainting of taste of animal meat with skin. The skin has a less desirable taste than meat of animals and also deteriorates more rapidly than meat, leaving a less desirable deterioration flavor on the meat. Also, allowing skinned meat to cool in clear air overnight is advantageous aging that improves its taste and storage capacity. This invention provides an on-site capability comparable to the most effective meat-processing plants.

Examples of animal hoists and carriers that are the most closely related, but which are different devices by being only transport and lift apparatuses are described in the following patent documents:

| | | Issue |
|---|---|---|
| U.S. Pat. No. | Inventor | Date |
| 6,109,855 | Vela-Cuellar | 08/29/2000 |
| 5,791,858 | Sasser | 08/11/1998 |
| 5,788,095 | Watson | 08/04/1998 |
| 4,903,372 | Jones | 02/27/1990 |
| 4,806,063 | York | 02/21/1989 |
| 4,431,121 | Bensette | 02/14/1984 |
| 4,338,703 | Tanner | 07/13/1982 |
| 4,045,040 | Fails | 08/30/1977 |

### SUMMARY OF THE INVENTION

Objects of patentable novelty and utility taught by this invention are to provide an animal skinner which:

provides fast, convenient and clean skinning of animals proximate where slaughtered or where transported; and

provides a hauling bracket for transporting animal bodies on backs of trucks and cars.

This invention accomplishes these and other objectives with an animal skinner having an animal fastener on a hoist vertically above a skin puller on an upright that supports an animal body and skin-pulling tension intermediate the animal fastener and the skin puller. The animal fastener is preferably a line having a loop or hook for fastening of a head, neck or upper portion of an animal to be skinned while being hoisted with the hoist. The hoist is preferably a winch, pulley or block and tackle having a crank or control line accessible conveniently to a person skinning the animal. The skin puller can include skin fasteners on a skin spool onto which skin of the animal is wound controllably proximate a low portion of the upright while the animal is being hoisted progressively with the hoist. Optionally, the skin puller can include arrayed animal fasteners anchored to the low portion of the upright for pulling the skin in opposition to upward movement of the animal with the hoist. Preferably, the upright is anchored to a trailer-hitch of a motor vehicle, but can be anchored otherwise or optionally substituted by a pole, a tree or other upright to which the hoist and the skin puller are attachable with adequate support and separation.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a side elevation view of an embodiment having an upright that is a trailer-hitch rod;

FIG. 2 is an end elevation view of the FIG. 1 illustration with a head loop as an animal fastener;

FIG. 3 is a bottom portion of the FIG. 2 illustration having a torsional motor for operation of a hoist;

FIG. 4 is a side view of a bottom of the animal skinner having a wheel ratchet for one-way unwinding control of a skin puller that is described in relation to FIGS. 1-2;

FIG. 5 is a side view of the bottom of the animal skinner having a torsional spring for tensioning and for one-way unwinding control of the skin puller that is described in relation to FIGS. 1-2;

FIG. 6 is a side elevation view of an embodiment having an upright that is a surface-based rod;

FIG. 7 is a side elevation view of an embodiment having an upright that is a pole or a tree;

FIG. 8 is a top view of the skin puller on the FIG. 7 embodiment;

FIG. 9 is a side elevation view of a back portion of the FIG. 1 embodiment being used to skin a deer; and

FIG. 10 is a rear elevation view of an un-skinned animal having skin-separation cuts for method of using this animal skinner.

### DESCRIPTION OF PREFERRED EMBODIMENT

Listed numerically below with reference to the drawings are terms used to describe features of this invention. These terms and numbers assigned to them designate the same features throughout this description.

| | |
|---|---|
| 1. | Hoist |
| 2. | Animal fastener |
| 3. | Skin puller |
| 4. | Upright |
| 5. | Animal body |
| 6. | Animal skin |
| 7. | Skin fastener |
| 8. | Head loop |
| 9. | Neck |
| 10. | Head hook |
| 11. | Head |
| 12. | Hang line |
| 13. | Winch |
| 14. | Winch crank |
| 15. | Block and tackle |
| 16. | Pulley-control line |
| 17. | Trailer-hitch rod |
| 18. | Trailer hitch |
| 19 | Motor Vehicle |
| 20. | Surface-based rod |
| 21. | Base portion |
| 22. | Surface |
| 23. | Pole |
| 24. | Skin spool |
| 25. | Spool crank |
| 26. | Wheel ratchet |
| 27. | Spool axle |
| 28. | Torsional spring |
| 29. | Arrayer |
| 30. | First front leg |
| 31. | Second front leg |
| 32. | First rear leg |
| 33. | Second rear leg |
| 34. | Inside cavity |
| 35. | Head line |
| 36. | Neck line |
| 37. | First-front-foot line |
| 38. | Second-front-foot |
| | line |
| 39. | First-front-leg line |
| 40. | Second-front-leg line |
| 41. | First rear-foot line |
| 42. | Second rear-foot line |
| 43. | First-rear-leg line |
| 44. | Second-rear-leg line |
| 45. | Knees |
| 46. | Hoofs |
| 47. | Tail |
| 48. | Horizontal top rod |
| 49. | Torsional motor |

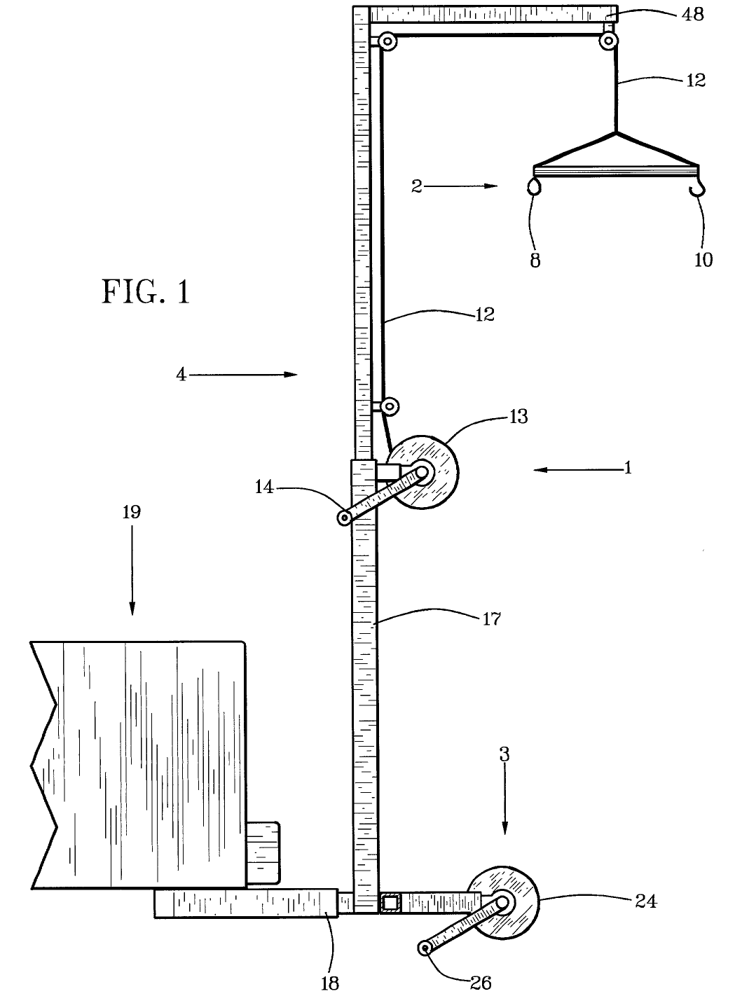

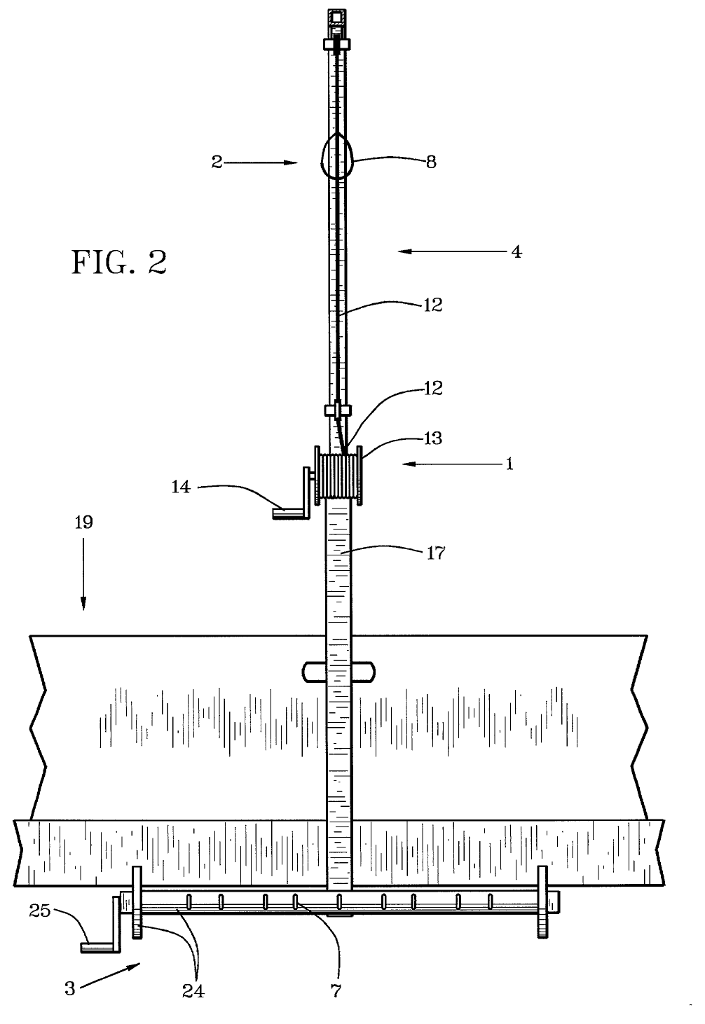

Referring first to FIGS. 1-2 and 9, a hoist 1 having an animal fastener 2 vertically above a skin puller 3 on an upright 4 supports an animal body 5 in addition to supporting skin-pulling tension of animal skin 6 that is in controllably skin-pulling tension intermediate the animal fastener 2 and the skin puller 3 which has one or more skin fasteners 7 for attachment of the animal skin 6 to the skin puller 3.

The animal fastener 2 can include a head loop 8 for encircling a neck 9 of the animal body for lift-fastener attachment of the animal body 5 to the hoist 1. Optionally, the animal fastener 2 can include a head hook 10 for hooking a head 11 proximate the neck 9 of the animal body 5 for lift-fastener attachment of the animal body 5 to the hoist 1.

Preferably, the hoist 1 includes a hang line 12 wound on a winch 13 on the upright 4 and has a winch crank 14 proximate a predetermined hand height on the upright 4.

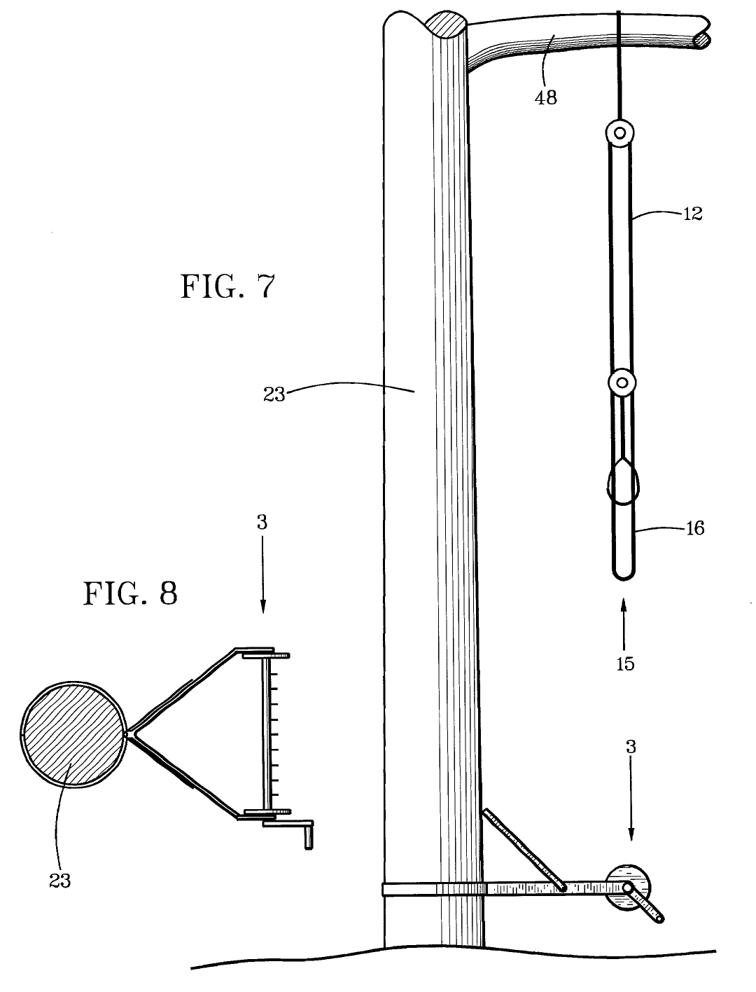

Referring to FIG. 7, a hoist can include a block and tackle 15 having a pulley-control line 16 proximate a predetermined hang height on the upright 4.

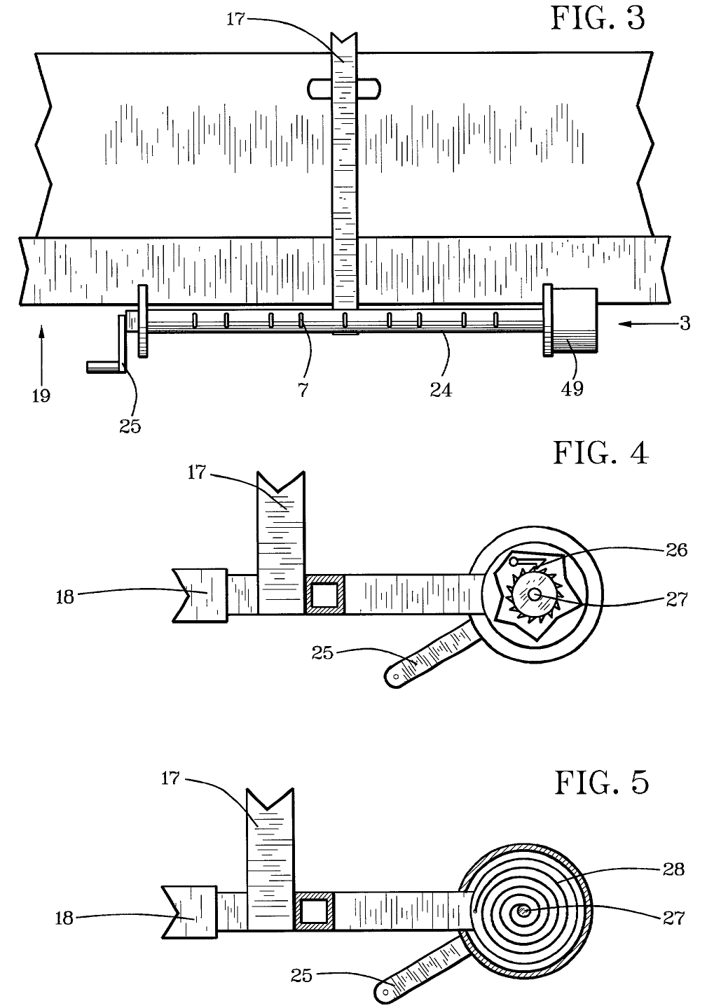

Referring to FIGS. 1-3, the upright 4 can include a trailer-hitch rod 17 having a bottom portion attachable to a trailer hitch 18 of a motor vehicle 19. The trailer hitch 18 shown employs a standard square-tube for receiving hitch members and the motor vehicle 19 shown represents a back end of a pickup truck.

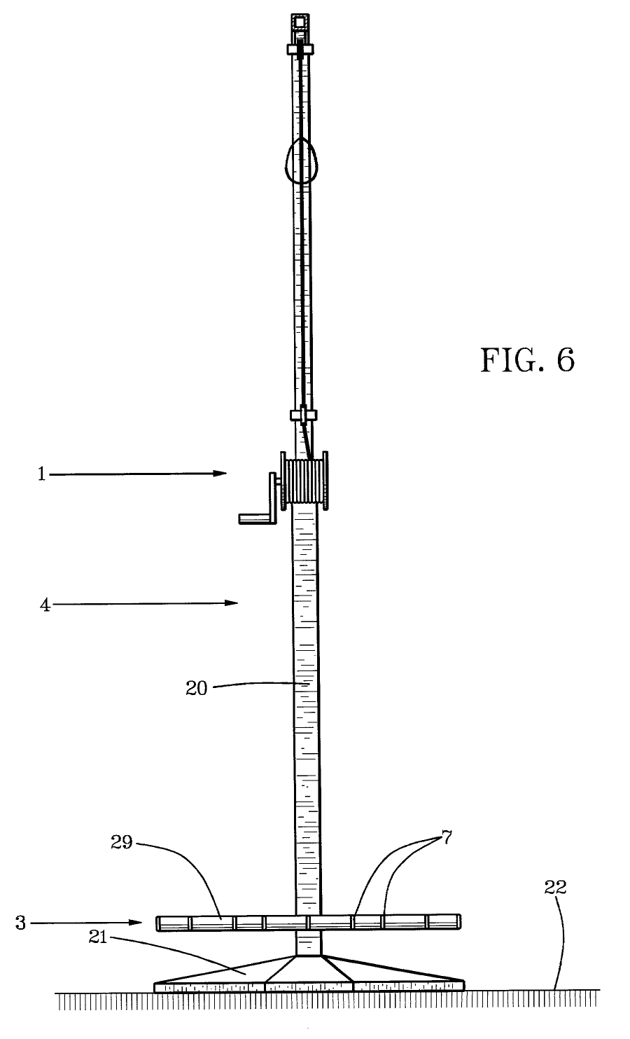

Referring to FIG. 6, the upright 4 can include a surface-based rod 20 having a base portion 21 supportable on a surface 22.

Referring to FIGS. 7-8, the upright 4 can include a selected upright member which can be a pole 23 or a tree to which the skin puller 3 is attached. A horizontal top rod 48 is desirable on the upright 4 for some use conditions in which the animal body 5 interferes with items like the motor vehicle 19 at the bottom but not necessarily for others.

Referring to FIGS. 1-3, 6-7, and 9-10, the skin puller 3 includes a skin spool 24 to which the animal skin 6 is attached with one or more of the skin fasteners 7 for being spooled onto the skin spool 24. The skin spool 24 can have a spool crank 25 for hand rotation and is situated proximate a predetermined low portion of the upright 4.

Referring to FIG. 4, the skin spool 24 can include a wheel ratchet 26 to prevent un-spooling of the animal skin 6 from the skin spool 24 by un-spooling rotation of spool axle 27 of the skin spool 24.

Referring to FIG. 5, the skin spool 24 can include a torsional spring 28 to prevent un-spooling of the animal skin 6 from the skin spool 24 and to apply pulling pressure intermediate the animal fastener 2 and the skin spool 24 described in relation to FIG. 1.

Referring to FIGS. 1-3, the skin spool 24 can include a torsional motor 49 to prevent un-spooling of the animal skin 6 from the skin spool 24 and to apply pulling pressure intermediate the animal fastener 2 and the skin puller 3.

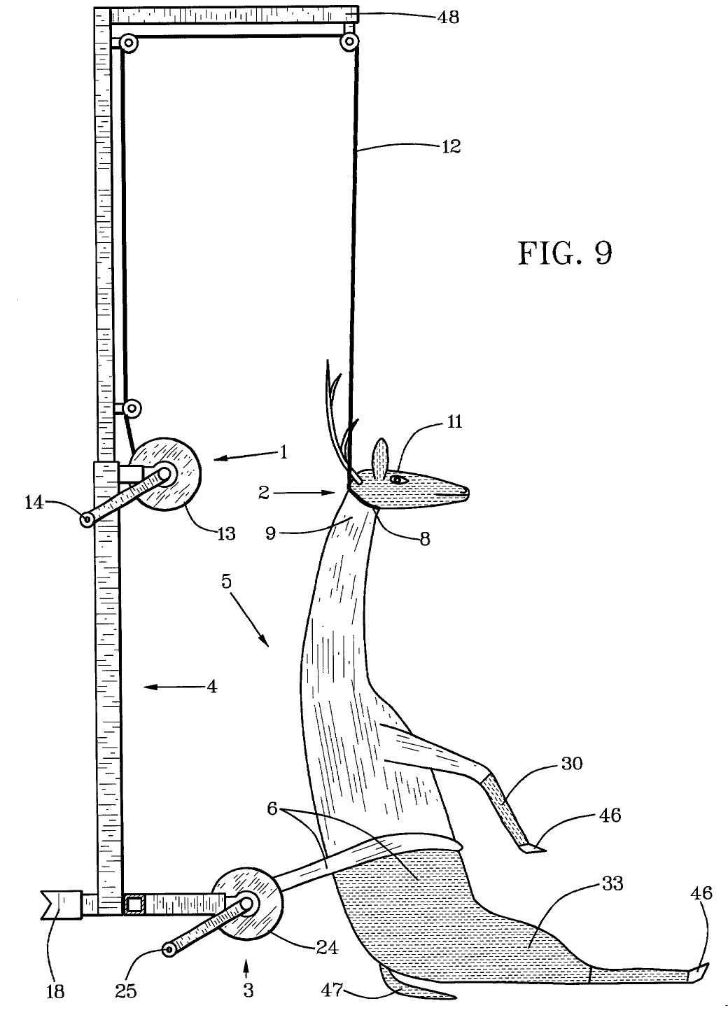

Referring to FIG. 6, the skin puller 3 can include one or more of the arrayed skin fasteners 7 on an arrayer 29 proximate a predetermined low portion of the upright 4 for pulling the animal skin 6 in opposition to upward movement of the animal body 5 shown in FIG. 9 with the hoist 1.

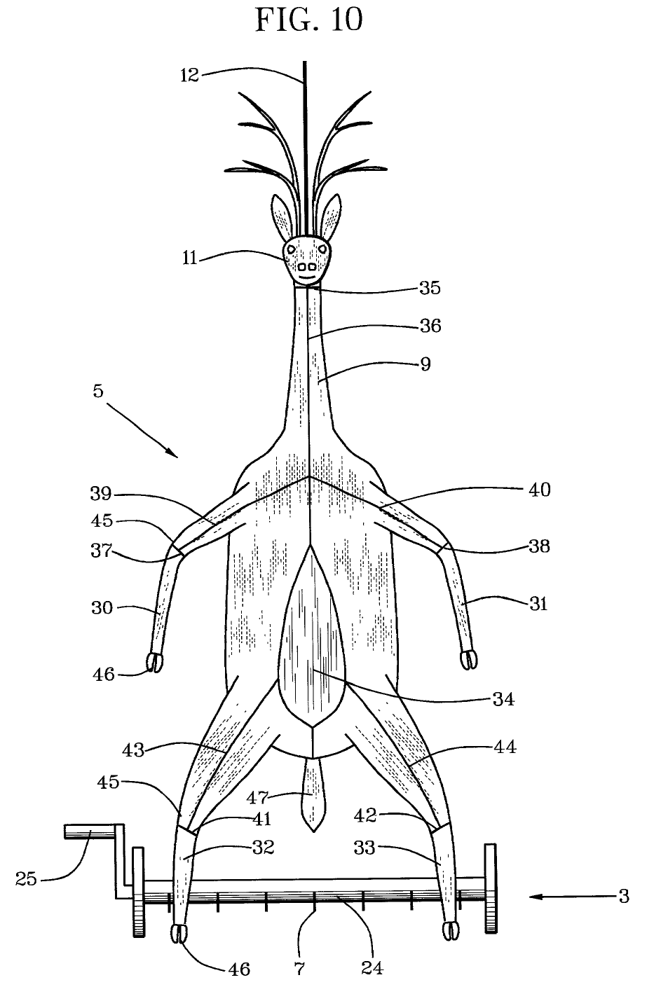

Referring to FIGS. 9-10, a use method for this animal skinner includes first cutting circumferentially parting lines and linearly parting lines on body appendages that include the neck 9, a first front leg 30, a second front leg 31, a first rear leg 32 and second rear leg 33. This skinning method assumes previously having cleaned insides out of an animal to leave an inside cavity 34 in the animal body 5 as shown in FIG. 10.

The circumferential parting line on the neck 9 is a head line 35. The linear parting line on the neck 9 is a neck line 36. The circumferential parting line on the first front leg 30 is the first-front-foot line 37. The circumferential parting line on the second front leg 31 is the second-front-foot line 38. The linear parting line on the first front leg 30 is the first-front-leg line 39. The linear parting line on the second front leg 31 is the second-front-leg line 40. The circumferential parting line on the first rear leg 32 is the first-rear-foot line 41. The circumferential parting line on the second rear leg 33 is the second-rear-foot line 42. The linear parting line on the first rear leg 32 is the first-rear-leg line 43. The linear parting line on the second rear leg 33 is the second-rear-leg line 44.

Optionally, the foot lines can be proximate knees 45 as shown or proximate hoofs 46. Optionally also, all skin-parting lines can be cut before attaching any of the animal skin 6 or can be cut immediately prior to attachment of the animal skin 6 proximate the cut being made.

On some animals, particularly farm animals, the animal skin 6 parts more easily from the animal body 5 than from wild animals like deer. Also some skin pullers 3 pull more pliably and controllably than others for causing the animal skin 6 to separate more easily. Further yet, some people are able to attach the animal skin better than others. There are some skill factors involved. For some individuals, for some animals and with some skin pullers, therefore, it may be necessary to hand-assist separation of the animal skin 6 from the animal body 5 in addition to pulling it with the skin puller 3.

The method in either event is to pull the animal skin 6 from the animal body 5 with expansion or pulling pressure between the animal fastener 2 and the skin puller 3, whether with or without hand-assist of skin separation and whether cutting all or part of the skin-parting lines before raising the animal body 5 by its head 11 in order for skinned portions of the animal body 5 to be raised from the ground where it can be kept clean and can be accessed conveniently by an individual hunter, farmer or meat processor.

Coincidentally and to represent all types of animals to be skinned with this animal skinner, the animal body 5 resembles opposite extremes of a deer at the head 11 and a hog at the animal body 5. Also, the hoofs 46 are more rounded like a sheep than pointed like a deer to broaden animal-skinning representation of the drawings.

Incidently, a tail 47 may not need a parting cut because it can turn inside out if desired for some animals.

A new and useful animal skinner having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. An animal skinner comprising:
a hoist having an animal fastener vertically above a skin puller on an upright that supports an animal body in addition to supporting skin-pulling tension intermediate the animal fastener and the skin puller; and
at least one skin fastener on the skin puller.

2. The animal skinner of claim 1 wherein:
the animal fastener includes a head loop for encircling a neck below a head of the animal body for lift-fastener attachment of the animal body to the hoist.

3. The animal skinner of claim 1 wherein:
the animal fastener includes a head hook for hooking a head proximate a neck of the animal body for lift-fastener attachment of the animal body to the hoist.

4. The animal skinner of claim 1 wherein:
the hoist includes a hang line wound on a winch on the upright and has a winch crank proximate a predetermined hand height on the upright.

5. The animal skinner of claim 1 wherein:
the hoist includes a block and tackle having a control line proximate a predetermined hang height on the upright.

6. The animal skinner of claim 1 wherein:
the upright includes a trailer-hitch rod having a bottom portion attachable to a trailer hitch of a motor vehicle.

7. The animal skinner of claim 1 wherein:
the upright includes a surface-based rod having a base portion supportable on a surface.

8. The animal skinner of claim 1 wherein:
the upright includes a selected upright object to which the hoist is attachable.

9. The animal skinner of claim 1 wherein:
the selected upright object includes a pole.

10. The animal skinner of claim 1 wherein:
the animal skin puller includes a skin spool to which the animal skin is attached with one or more skin fasteners for being spooled onto the skin spool;
the skin spool being proximate a predetermined low portion of the upright; and
the skin spool has a spool crank.

11. The animal skinner of claim 10 wherein:
the skin spool has a wheel ratchet to prevent un-spooling of the animal skin from the skin spool.

12. The animal skinner of claim 10 wherein:
the skin spool has a torsional spring to prevent un-spooling of the animal skin from the skin spool and to apply pulling pressure intermediate the animal fastener and the skin puller.

13. The animal skinner of claim 1 wherein:
the skin puller includes a skin spool to which the animal skin is attached with one or more skin fasteners for being spooled onto the skin spool;
the skin spool being proximate a predetermined low portion of the upright; and
the skin spool has a torsional motor to prevent un-spooling of the animal skin from the skin spool and to apply pulling pressure intermediate the animal fastener and the skin puller.

14. The animal skinner of claim 1 wherein:
the skin puller includes one or more arrayed skin fasteners proximate a predetermined low portion of the upright for pulling the animal skin in opposition to upward movement of the animal body with the hoist.

15. An animal skinner comprising:
a hoist having an animal fastener vertically above a skin puller on an upright that supports an animal body in addition to supporting skin-pulling tension intermediate the animal fastener and the skin puller;
at least one skin fastener on the skin puller;
the animal fastener includes a head loop for encircling a neck below a head of the animal body for lift-fastener attachment of the animal body to the hoist;
the hoist includes a winch having a pulley wheel proximate a predetermined hang height on the upright and having a winch crank proximate a predetermined hand height on the upright; and
the upright includes a rod having a base portion attachable to a trailer hitch of a motor vehicle.

16. The animal skinner of claim 15 wherein:
the skin puller includes a skin spool to which the animal skin is attached with one or more skin fasteners for being spooled onto the skin spool;
the skin spool being proximate a predetermined low portion of the upright; and
the skin spool has a spool crank.

17. The animal skinner of claim 15 wherein:
the skin puller includes one or more arrayed skin fasteners proximate a predetermined low portion of the upright for pulling the animal skin in opposition to upward movement of the animal body with the hoist.

18. A method comprising the following steps for using an animal skinner comprising a hoist having an animal fastener vertically above a skin puller on an upright that supports an animal body in addition to supporting skin-pulling tension intermediate the animal fastener and the skin puller; and at least one skin fastener on the skin puller:
attaching an upper neck portion of the animal body to the animal fastener;
cutting a head line circumferentially around a neck for separation of the animal skin from a head of the animal body;
cutting a neck line in the animal skin linearly along a front of the neck of the animal body;
attaching neck skin to the skin puller circumferentially opposite from the neck line;
pulling the neck skin loose from the neck of the animal with the skin puller;
cutting a first-front-foot line circumferentially around a first front leg of the animal body;
cutting a first-front-leg line in the animal skin linearly along the first front leg;
cutting a second-front-foot line circumferentially around a second front leg of the animal body;
cutting a second-front-leg line in the animal skin linearly along the second front leg;
attaching front-leg skin of the first front leg and the second front leg to the skin puller;
pulling the leg skin loose from the first front leg and from the second front leg with the skin puller;
pulling the animal skin loose from back and side portions of the animal body with the skin puller;
cutting a first-rear-foot line circumferentially around a first rear leg of the animal body;
cutting a first-rear-leg line in the animal skin linearly along the first rear leg;
cutting a second-rear-foot line circumferentially around a second rear leg of the animal body;
cutting a second-rear-leg line in the animal skin linearly along the second rear leg;
attaching rear-leg skin of the first rear leg and the second rear leg to the skin puller;
pulling the leg skin loose from the first rear leg and from the second rear leg with the skin puller; and
pulling the animal skin loose from rump portions of the animal body with the skin puller.

19. The method of claim 18 wherein pulling skin loose from portions of the animal body with the skin puller includes increasing contractive pressure intermediate the hoist and the skin puller by cranking the hoist to raise the animal body higher.

20. The method of claim 18 wherein pulling skin loose from portions of the animal body with the skin puller includes increasing contractive pressure intermediate the hoist and the skin puller by pulling the skin puller downwardly.

21. The method of claim 18 wherein pulling skin loose from portions of the animal body with the skin puller includes increasing contractive pressure intermediate the hoist and the skin puller by winding the animal skin onto a skin spool of the skin puller.

22. The method of claim 18 wherein pulling skin loose from portions of the animal body with the skin puller includes increasing contractive pressure intermediate the hoist and the skin puller by attaching the skin puller to sequentially lower portions of the animal skin to decrease distance between the skin puller and the animal body while the animal skin is being pulled from the animal body.

23. The method of claim 18 wherein the steps of attaching the neck skin to the skin puller; pulling the neck skin loose from the neck; attaching the front-leg skin of the first front leg and the second front leg to the skin puller; pulling the animal skin loose from the first front leg and from the second front leg; pulling the animal skin loose from the back and sides; attaching rear-leg skin of the first rear leg and of the second rear leg to the skin puller; and pulling the leg skin loose from the first rear leg and from the second rear leg are accomplished after first cutting the head line; cutting the neck line; cutting the first front-foot line; cutting the first front-leg line; cutting the second front-foot line; cutting the second front-leg line; cutting the first rear-foot line; cutting the first rear-leg line; cutting the second rear-foot line; and cutting the second rear-leg line.

24. A method comprising the following steps for using an animal skinner comprising a hoist having an animal fastener vertically above a skin puller on an upright that supports an animal body in addition to supporting skin-pulling tension intermediate the animal fastener and the skin puller; and at least one skin fastener on the skin puller:
attaching an upper neck portion of the animal body to the animal fastener;
cutting a head line circumferentially around a neck for separation of the animal skin from a head of the animal body; cutting a neck line in the animal skin linearly along the neck of the animal body;
attaching neck skin to the skin puller circumferentially opposite from the neck line;
pulling the neck skin loose from the neck of the animal with the skin puller while simultaneously hand-assisting separation of the animal skin from the neck of the animal body as necessary;
cutting a first-front-foot line circumferentially around a first front leg of the animal body;
cutting a first-front-leg line in the animal skin linearly along the first front leg;
cutting a second-front-foot line circumferentially around a second front leg of the animal body;
cutting a second-front-leg line in the animal skin linearly along the second front leg;
attaching front-leg skin of the first front leg and the second front leg to the skin puller;
pulling the leg skin loose from the first front leg and from the second front leg with the skin puller while simultaneously hand-assisting separation of the leg skin from the first front leg and from the second front leg as necessary;
pulling the animal skin loose from back and side portions of the animal body while simultaneously hand-assisting separation of the animal skin from the back and side portions of the animal body as necessary;
cutting a first-rear-foot line circumferentially around a first rear leg of the animal body;
cutting a first-rear-leg line in the animal skin linearly along the first rear leg;
cutting a second-rear-foot line circumferentially around a second rear leg of the animal body;
cutting a second-rear-leg line in the animal skin linearly along the second rear leg;
attaching rear-leg skin of the first rear leg and the second rear leg to the skin puller;
pulling the leg skin loose from the first rear leg and from the second rear leg with the skin puller while simultaneously hand-assisting separation of the leg skin from the first rear leg and from the second rear leg as necessary; and
pulling the animal skin loose from rump portions of the animal body while simultaneously hand-assisting separation of the animal skin from the rump portions of the animal body as necessary.

25. The method of claim 24 wherein the steps of attaching the neck skin to the skin puller; pulling the neck skin loose from the neck; attaching the front-leg skin of the first front leg and the second front leg to the skin puller; pulling the animal skin loose from the first front leg and from the second front leg; pulling the animal skin loose from the back and sides; attaching rear-leg skin of the first rear leg and of the second rear leg to the skin puller; and pulling the leg skin loose from the first rear leg and from the second rear leg are accomplished after first cutting the head line; cutting the neck line; cutting the first front-foot line; cutting the first front-leg line; cutting the second front-foot line; cutting the second front-leg line; cutting the first rear-foot line; cutting the first rear-leg line; cutting the second rear-foot line; and cutting the second rear-leg line.
